(19) United States
(12) Patent Application Publication
(10) Pub. No.: US 2026/0269617 A1
(43) Pub. Date: Sep. 10, 2026

(54) POWER BRANCHING DEVICE, POWER BRANCHING METHOD, AND STORAGE MEDIUM

(71) Applicant: HONDA MOTOR CO., LTD., Tokyo (JP)

(72) Inventors: Kairi Mochizuki, Wako-shi (JP); Shohei Nakamura, Tokyo (JP)

(21) Appl. No.: 19/467,864

(22) Filed: Feb. 3, 2026

(30) Foreign Application Priority Data
Feb. 3, 2025 (JP) 2025-016212

(51) Int. Cl. H02J 3/007; H01R 13/66; H01R 25/00; H02J 3/175; H02J 105/10; H02J 105/46; H02J 105/50; H02J 105/52; H02J 107/20

(52) U.S. Cl. CPC H02J 3/007; H01R 13/6691; H01R 25/003; H02J 3/175; H02J 2105/10; H02J 2105/46; H02J 2105/51; H02J 2105/52; H02J 2107/20

(57) ABSTRACT

A power branching device includes a plurality of connection portions to which a plurality of power-consuming devices are detachably connected, respectively, an acquisition unit configured to acquire priority/subordination degrees that are priority degrees or subordination degrees of the plurality of power-consuming devices connected to the plurality of connection portions, respectively, and a notification unit configured to notify a user of one priority/subordination degree, which is the priority/subordination degree of one power-consuming device acquired by the acquisition unit among the plurality of power-consuming devices, in association with one connection portion which is the connection portion to which the one power-consuming device is connected.

### CROSS-REFERENCE TO RELATED APPLICATION

Priority is claimed on Japanese Patent Application No. 2025-016212, filed February 03, 2025, the content of which is incorporated herein by reference.

### BACKGROUND OF THE INVENTION

### Field of the Invention

The present invention relates to a power branching device, a power branching method, and a storage medium.

Conventionally, technology for controlling an interrupting means provided between a power supply source and each of a plurality of power outlets has been proposed (see, for example, PCT International Publication No. WO/2023/175733). As disclosed in PCT International Publication No. WO/2023/175733, it is determined whether or not there is a power shortage state based on a difference between electric power supplied from the power supply source and electric power consumed by loads connected to the plurality of power outlets, priority degrees of the plurality of power outlets are determined, and the interrupting means associated with a power outlet whose priority degree is low is set to an interrupted state when it is determined that there is a power shortage state.

### SUMMARY OF THE INVENTION

Meanwhile, in sites during emergency such as evacuation shelters during disasters, the supply of goods takes top priority, and the supplied goods may not always be appropriately managed. For example, a situation in which electric power supplied from an emergency power supply is branched or distributed using a power strip (power branching device) is conceivable. However, if which devices are connected to which power strip is not properly managed, there is a possibility that sufficient and stable electric power will not be supplied to critical power loads related to human life and health, such as medical devices or air-conditioning systems. In contrast, in the technique disclosed in PCT International Publication No. WO/2023/175733, the supply and cutoff of electric power according to a priority degree of a connected load can be controlled, but it is not possible to suppress inappropriate human actions such as an improper load connection or an erroneous load disconnection, which may endanger human life or health.

An aspect of the present invention is to provide a power branching device, a power branching method, and a program capable of alerting a user according to a usage status.

A power branching device, a power branching method, and a storage medium according to the present invention adopt the following configurations.
(1): According to an aspect of the present invention, there is provided a power branching device including: a plurality of connection portions to which a plurality of power-consuming devices are detachably connected, respectively; an acquisition part configured to acquire priority/subordination degrees that are priority degrees or subordination degrees of the plurality of power-consuming devices connected to the plurality of connection portions, respectively; and a notification part configured to notify a user of one priority/subordination degree, which is the priority/subordination degree of one power-consuming device acquired by the acquisition part among the plurality of power-consuming devices, in association with one connection portion which is the connection portion to which the one power-consuming device is connected.
(2): In the above-described aspect (1), the power branching device further includes a first controller configured to control a first connection portion group among the plurality of connection portions; and a second controller configured to control a second connection portion group different from the first connection portion group.
(3): In the above-described aspect (2), the first controller includes a first transmission part configured to transmit first identification information indicating the first connection portion group, and the second controller includes a second transmission part configured to transmit second identification information indicating the second connection portion group.
(4): In the above-described aspect (3), the first connection portion group and the second connection portion group are electrically connectable via a power line, and the first transmission part transmits the first identification information to the second controller via the power line.
(5): In the above-described aspect (3) or (4), the first connection portion group and the second connection portion group are electrically connectable via a power line, and the second controller includes a reception part configured to receive the first identification information via the power line.
(6): In the above-described aspect (3), the first controller and the second controller identify whether the first controller or the second controller is a main controller or a sub-controller based on the first identification information and the second identification information.
(7) In the above-described aspect (6), when the first controller is the main controller and the second controller is the sub-controller, the second transmission part measures power consumption of the connected power-consuming device for each connection portion included in the second connection portion group and transmits to the first controller, and the first controller outputs proposal information for proposing a change of connection-destination-connection-part of the power-consuming devices so that total power consumption between the first connection portion group and the second connection portion group is leveled.
(8): In the above-described aspect (7), while excluding the connection portion connected with the power-consuming device having a high priority/subordination degree among the first connection portion group and the second connection portion group from an object of the change, the first controller decides the connection portion which is the object of the change so that the total power consumption is leveled.
(9): In the above-described aspect (3), the power branching device further includes a wireless communication part configured to perform wireless communication with an other power branching device, wherein the first transmission part transmits the first identification information to a third controller that is the first controller of the other power branching device, via the wireless communication part, and receives third identification information indicating a third connection portion group that is the first connection portion group of the other power branching device from the third controller.
(10): In the above-described aspect (9), the first controller identifies, based on the first identification information and the third identification information, whether the first controller itself is a first main controller representing main controllers or a second main controller that is a main controller other than the first main controller.
(11): In the above-described aspect (10), when the first controller is the first main controller and the third controller is the second main controller, the first main controller acquires information indicating power consumption of the power-consuming devices connected to the third connection portion group and indicating the power consumption for each connection portion included in the third connection portion group from the third controller, and the first main controller outputs proposal information for proposing a change of connection-destination-connection-part of the power-consuming devices so that total power consumption among the first connection portion group, the second connection portion group, the third connection portion group, and a fourth connection portion group that is the second connection portion group of the other power branching device is leveled.
(12): In the above-described aspect (11), while excluding the connection portion connected with the power-consuming device having a high priority/subordination degree among the first connection portion group, the second connection portion group, the third connection portion group, and the fourth connection portion group from an object of the change, the first controller decides the connection portion which is the object of the change so that the total power consumption is leveled.
(13): In the above-described aspect (1), the power branching device further includes an operation part configured to receive an operation of the user, wherein, when an operation for changing a priority/subordination degree setting is input, the first controller and the second controller request the user to input credential information and permit the change in the setting only when the input information matches credential information registered in advance.
(14): According to an aspect of the present invention, there is provided a power branching method for a power branching device including: a plurality of connection portions to which a plurality of power-consuming devices are detachably connected, respectively, and a plurality of notification parts corresponding to the plurality of connection portions, respectively, the method including acquiring priority/subordination degrees that are priority degrees or subordination degrees of the plurality of power-consuming devices connected to the plurality of connection portions, respectively; and notifying a user of one priority/subordination degree, which is the acquired priority/subordination degree of one power-consuming device among the plurality of power-consuming devices, by using the notification part which is among the plurality of notification parts and which is corresponding to one connection portion that is the connection portion to which the one power-consuming device is connected.
(15): According to an aspect of the present invention, there is provided a non-transitory computer-readable storage medium storing a computer program for causing a computer of a power branching device including a plurality of connection portions to which a plurality of power-consuming devices are detachably connected, respectively, and a plurality of notification parts corresponding to the plurality of connection portions, respectively, to execute: a process for acquiring priority/subordination degrees that are priority degrees or subordination degrees of the plurality of power-consuming devices connected to the plurality of connection portions, respectively; and a process for notifying a user of one priority/subordination degree, which is the acquired priority/subordination degree of one power-consuming device among the plurality of power-consuming devices, by using the notification part which is among the plurality of notification parts and which is corresponding to one connection portion that is the connection portion to which the one power-consuming device is connected.

According to the aspects (1) to (15), it is possible to alert a user of a power branching device according to a usage status.

### BRIEF DESCRIPTION OF THE DRAWINGS

FIG. 1 is a diagram showing an example of a configuration of a power distribution device according to a first embodiment.

FIG. 2 is a block diagram showing an example of a functional configuration of the power distribution device according to the first embodiment.

FIG. 3 is a diagram showing an example of setting information about priority device settings.

FIG. 4 is a diagram showing a first modification example of the power distribution device.

FIG. 5 is a diagram showing a second modification example of the power distribution device.

FIG. 6 is a diagram showing an example of a power branching device according to another modification example.

FIG. 7 is a diagram showing an example of a configuration of a power distribution device according to a second embodiment.

FIG. 8 is a diagram showing an example of a configuration of a power distribution device according to a second embodiment.

FIG. 9 is an image diagram of power line communication (PLC) communication.

FIG. 10 is a diagram showing an example of a load distribution proposed by a load distribution proposal part.

FIG. 11 is a diagram showing an example of a configuration of a power distribution device according to a third embodiment.

FIG. 12 is a diagram showing an example of a configuration of a power distribution device according to a third embodiment.

FIG. 13 is a diagram showing an example of a global load distribution proposed by a load distribution proposal part.

FIG. 14 is a diagram showing an example of a configuration of a power distribution device.

### DETAILED DESCRIPTION OF THE INVENTION

Hereinafter, embodiments of a power distribution device, a power distribution method, and a program according to the present invention will be described with reference to the drawings.

### First Embodiment

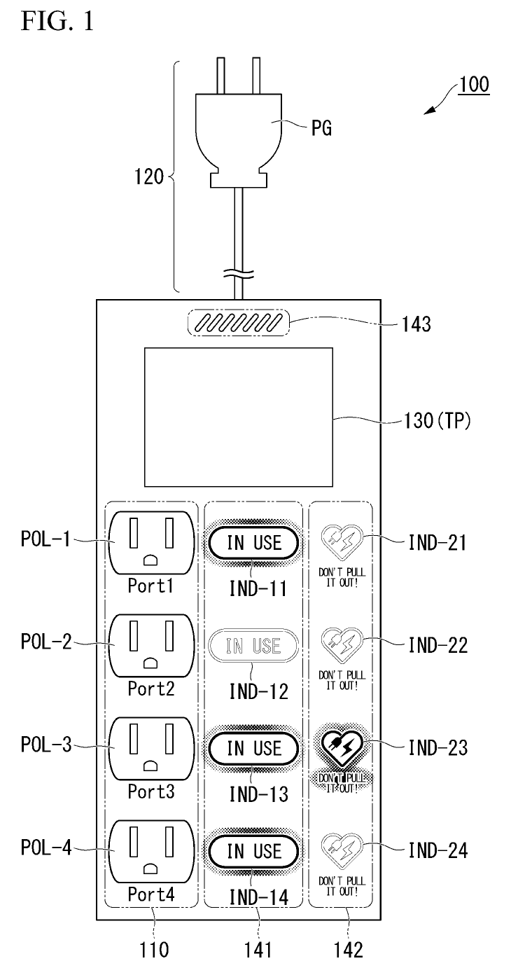

FIG. 1 is a diagram showing an example of a configuration of a power distribution device 100 according to a first embodiment. The power distribution device 100 is a device referred to as an office automation (OA) strip, a power strip, or a power distribution unit (PDU), which distributes and supplies electric power supplied from an external alternating current (AC) power supply to one or more loads connected to the device itself. The power distribution device 100 includes a load connection portion 110, a power connection part 120, an operation part 130, a first notification part 141, a second notification part 142, and a third notification part 143.

The load connection portion 110 is an interface for connecting load devices to the power distribution device 100. For example, the load connection portion 110 is a so-called power outlet. The power plug of a load device is inserted into the load connection portion 110. The power distribution device 100 supplies AC power to the load devices connected to the load connection portion 110. FIG. 1 shows a case where the load connection portion 110 includes four ports POL-1 to POL-4 as an example. It is assumed that the load connection portion 110 internally includes various types of sensors for detecting whether or not a load device is connected and detecting the power consumption of a connected load device.

The power connection part 120 is an interface for connecting the power distribution device 100 to the external AC power supply (external power supply). The power connection part 120 is a so-called power cord having a power plug PLG at its end. When the power plug PLG is inserted into a power outlet of the external power supply, electric power from the external power supply is supplied to the power distribution device 100 via the power connection part 120.

The operation part 130 is a functional unit that receives operation inputs to the power distribution device 100. FIG. 1 shows an example in which the operation part 130 is a touch panel TP. For example, the operation part 130 displays a menu screen for various types of operations related to the power distribution device 100 and receives an operation input from a user for the menu screen. The operation part 130 receives operations related to operation settings of the power distribution device 100. The operation part 130 may be implemented by a combination of a display device such as a liquid crystal monitor and an input device such as a keyboard.

The first notification part 141 is a functional unit of providing a visual notification of the usage status of the load connection portion 110. FIG. 1 shows first indicators IND-11 to IND-14 corresponding to four power outlets POL-1 to POL-4 of the load connection portion 110 as an example of the first notification part 141. Each of the first indicator IND-11 to IND-14 notifies that the corresponding power outlets POL-1 to POL-4 are in use by an emission of light (turned ON state) and notifies that the corresponding power outlets POL-1 to POL-4 are not in use by a non-emission of light (turned OFF state).

In addition, the first notification part 141 may be configured to indicate whether or not each load connection portion 110 is in use according to the ON state of an individual indicator instead of indicating whether or not each load connection portion 110 is in use according to the ON/OFF state of the indicator. Moreover, for example, the first notification part 141 may be configured to indicate the usage status of the load connection portion 110 as an image (including text) by a display device such as a liquid crystal monitor. Moreover, the usage status of the load connection portion 110 may be represented not only by turning on or off the indicator but also by any visually recognizable aspect, such as a color or flashing pattern of the indicator.

The second notification part 142 is a functional unit of providing a notification indicating a priority-device connection when a load device connected to the load connection portion 110 is a priority device. As an example, the priority device is a power consumption device for which stable power supply must be ensured and is a device whose operation failure may affect human health or life, such as a medical device, and examples include servers, communication equipment, and monitoring devices. FIG. 1 shows second indicators IND-21 to IND-24 corresponding to the four power outlets POL-1 to POL-4 of the load connection portion 110 as an example of the second notification part 142. Each of the second indicator IND-21 to IND-24 notifies that the load device connected to one of the corresponding power outlets POL-1 to POL-4 is a priority device according to the ON state and notifies that the corresponding load device is not a priority device according to the OFF state.

In addition, the second notification part 142 may be configured to indicate whether or not a load device is a priority device by turning on an individual indicator instead of indicating whether or not a load device is a priority device by turning on or off the indicator. Moreover, for example, the second notification part 142 may be configured to display whether or not a load device is a priority device as an image (including text) using a display device such as a liquid crystal monitor. Moreover, whether or not a load device is a priority device may be represented not only by turning on or off the indicator but also by any visually recognizable aspect, such as a color or flashing pattern of the indicator.

The third notification part 143 is a functional unit of providing an audible notification of information about the power distribution device 100. The third notification part 143 includes a speaker SP for outputting a sound. For example, the third notification part 143 may output a sound related to an operation menu screen displayed on the operation part 130, a sound for providing a notification of the usage status of the load connection portion 110, or a sound for providing a notification of whether or not a load device is a priority device. In addition to these, the third notification part 143 may output a sound indicating any information about the power distribution device 100.

Operations of the operation part 130, the first notification part 141, the second notification part 142, and the third notification part 143 described above are controlled by a controller 160, which will be described below.

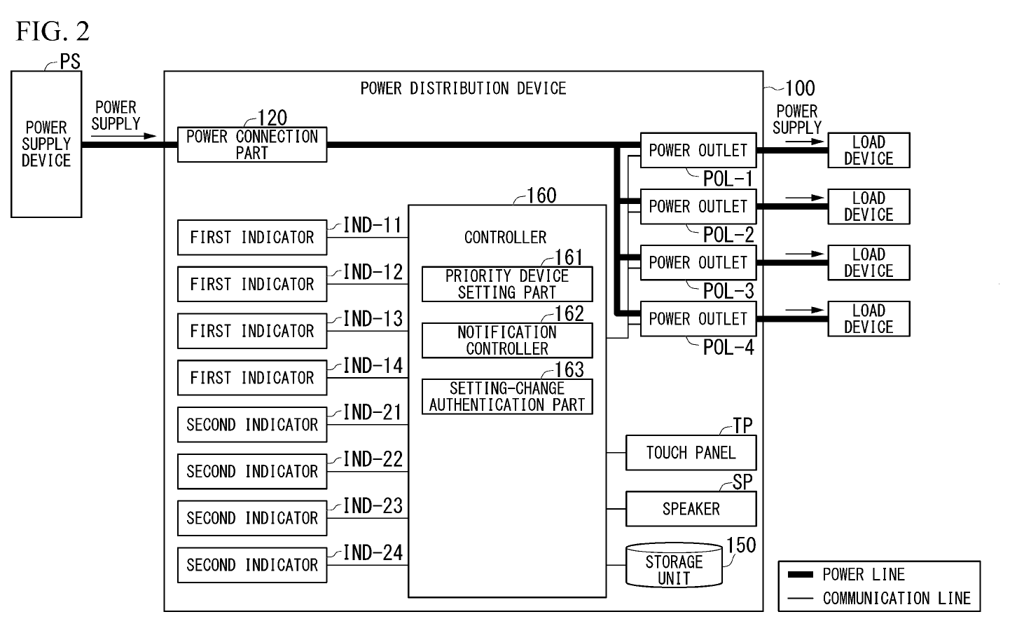

FIG. 2 is a block diagram showing an example of a functional configuration of the power distribution device 100 according to the first embodiment. The power distribution device 100 includes a storage unit 150 and the controller 160 in addition to the power connection part 120, the touch panel TP (operation part 130), the first indicators IND-11 to IND-14 (first notification part 141), the second indicators IND-21 to IND-24 (second notification part 142), and the speaker SP (third notification part 143) described above. Among these constituent elements, at least the controller 160 is implemented by a hardware processor such as a central processing unit (CPU) executing a program (software). Some or all of the above constituent elements may be implemented by hardware (including a circuit unit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (the non-transitory storage medium) such as a digital versatile disc (DVD) or a compact disc-read only memory (CD-ROM) and installed when the storage medium is mounted in a drive device.

The storage unit 150 is configured using a storage device such as an HDD, a solid-state drive (SSD), or a flash memory. The storage unit 150 stores programs to be executed by the controller 160, setting information to be referred to by those programs, and the like. In addition, the storage unit 150 may be used as a storage area for any information acquired or generated by the power distribution device 100.

The controller 160 is a functional unit of controlling the operations of the operation part 130, the first notification part 141, the second notification part 142, and the third notification part 143. The controller 160 is electrically connected to the load connection portion 110 and can recognize whether or not a load device is connected for each power outlet. Moreover, the controller 160 can recognize the power consumptions of the load devices connected to the power outlets. Moreover, the controller 160 can switch the presence or absence of the supply of power for the load device for each power outlet by controlling an internal relay circuit (not shown) of each power outlet. The controller 160 includes, for example, a priority device setting part 161, a notification controller 162, and a setting-change authentication part 163.

The priority device setting part 161 receives the user’s setting operation in relation to the setting of the power outlet (priority device setting) to which a priority device is connected. For example, the priority device setting part 161 causes a menu screen (setting screen) for receiving priority device setting operations to be displayed on the touch panel TP, records content input to the setting screen in setting information, and stores the setting information in the storage unit 150.

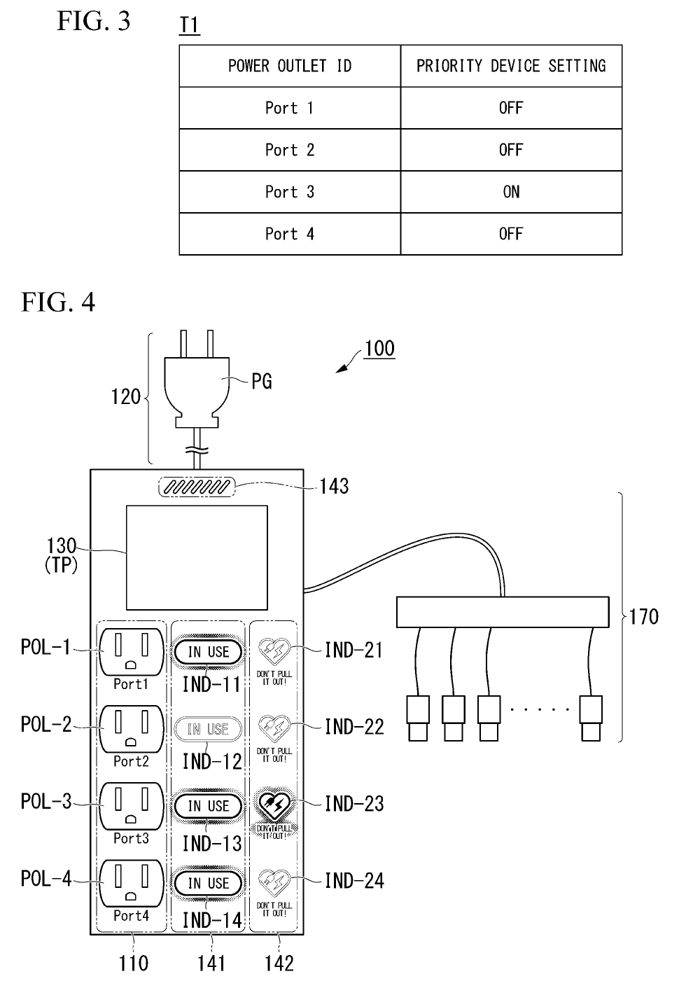

FIG. 3 is a diagram showing an example of setting information about the priority device setting. The setting information about the priority device setting is stored, for example, in an aspect of a setting information table T1 as shown in FIG. 3. The setting information table T1 has, for example, respective values of power outlet IDs and the priority device settings. The power outlet ID is identification information of each power outlet provided in the load connection portion 110. In the present embodiment, for ease of description, the power outlet IDs are written under the power outlets (see FIG. 1). That is, power outlet IDs “Port 1” to “Port 4” correspond to power outlets POL-1 to POL-4, respectively. The setting information table T1 of FIG. 3 indicates a case where the power outlet POL-3 (“Port 3”) among the four power outlets POL-1 to POL-4 is set as a priority device power outlet and the other power outlets are not set as priority device power outlets. In this case, the load device connected to the power outlet POL-3 is regarded as a priority device and a first indicator IND-13 and a second indicator IND-23 corresponding thereto are turned on as shown in the example of FIG. 1.

Returning to FIG. 2, the notification controller 162 controls the first notification part 141, the second notification part 142, and the third notification part 143 so that notifications are provided according to the usage status of the load connection portion 110. More specifically, the notification controller 162 recognizes whether or not a load device is connected and the power consumption of the load device for each power outlet of the load connection portion 110, refers to the setting information table T1, and recognizes the priority device setting for each power outlet. The notification controller 162 controls the ON/OFF state of each of the corresponding first indicators IND-11 to IND-14 and the corresponding second indicators IND-21 to IND-24 based on the presence or absence of the recognized connection of the load device, the power consumption of the load device, and the content of the priority device setting.

More specifically, when the priority device setting of the power outlet to which the load device is connected is set to ON, the notification controller 162 turns on both the first indicator and the second indicator corresponding to the power outlet. Moreover, when the priority device setting of the power outlet to which a load device is connected is set to OFF, the notification controller 162 turns on the first indicator corresponding to the power outlet and turns off the second indicator. Moreover, for a power outlet to which no load device is connected, the notification controller 162 causes both the first indicator and the second indicator corresponding thereto to be turned off. In addition, the notification controller 162 may display information about the state of each indicator on the touch panel TP or output the information as a sound using the speaker SP.

At least a portion of the controller 160 can function as an “acquisition part.” Various aspects exist for acquiring the priority/subordination degree, which represents the priority or subordination degree of the power consumption device. In one example, the controller 160 may acquire the priority/subordination degree associated with each connection portion by reading (referencing) setting information (e.g., the setting information table T1 in FIG. 3) pre-stored in the storage unit 150 (internal acquisition). In another example, the controller 160 may acquire information indicating the priority/subordination degree by directly receiving from an external source (e.g., a tag attached to a load device) via a reading device such as an RFID reader described later (external acquisition). In yet another example, the priority/subordination degree may be acquired by receiving a setting command transmitted from an external server or mobile terminal via a wireless communication unit described later (communication acquisition).

The setting-change authentication part 163 performs an authentication process for determining the legitimacy of an operator when an operation related to a change in the priority device setting is received. For example, the setting-change authentication part 163 displays an input screen for credential information on the touch panel TP, requests the user to input the credential information, and permits the setting change when the input credential information matches registered credential information, and prohibits the setting change if the information does not match. The authentication may be based only on a password or based on an ID and a password. A timing at which the authentication process is executed may be any time before the setting change is confirmed in a flow of a series of processing steps related to the setting change. For example, the timing at which the authentication process is executed can be when the user attempts to display the setting screen or when the user attempts to confirm the changed setting. It is assumed that the registered credential information is stored in advance in the storage unit 150.

According to the power distribution device 100 of the first embodiment described above, it is possible to alert the user according to the usage status.

For example, in the power distribution device 100 of the first embodiment, when a load device is connected to a power outlet of the load connection portion 110, the first indicator corresponding to the power outlet is turned on. Thereby, because the user can accurately recognize the usage status of the power outlet, it is possible to suppress an erroneous disconnection of the power cord of the load device in use from the power outlet.

Moreover, in the power distribution device 100 of the first embodiment, a priority device setting can be registered for each power outlet of the load connection portion 110. When a load device is connected to a power outlet whose priority device setting is set to ON, both the first indicator and the second indicator corresponding to the power outlet are turned on. Thereby, the user can accurately recognize whether or not the load device in use is a priority device in accordance with the usage status of the power outlet. Thus, according to the power distribution device 100 of the first embodiment, it is possible to notify the user of the power outlet usage status while providing a stronger alert with respect to the handling of priority devices.

Moreover, for example, in the power distribution device 100 of the first embodiment, when the priority device setting is changed, the operator is requested to input credential information, such that a range in which the user can change the priority device settings can be defined. Thereby, because arbitrary or careless changes in the priority device settings can be suppressed, it is possible to enable a safer operation of the power distribution device 100.

### Modification Examples

Modification examples of the power distribution device 100 according to the first embodiment will be described below.

### First Modification Example

FIG. 4 is a diagram showing a first modification example of the power distribution device 100. Although the power distribution device 100 of the embodiment includes the load connection portion 110 that supplies AC power as a power supply means for the load device, the power distribution device 100 of the modification example further includes a second load connection portion 170 that supplies direct current (DC) power in addition to the load connection portion 110. It is only necessary for the second load connection portion 170 to include a built-in AC/DC converter that converts AC power into DC power and output the DC power. For example, a universal serial bus (USB) interface can be cited as an example of the second load connection portion 170. By providing such a second load connection portion 170, the power distribution device 100 can supply electric power to more load devices, thereby improving the convenience of the power distribution device 100.

In the power distribution device 100 shown in FIG. 4, the operation part 130 is configured to accept input of the maximum output power (rated capacity) of the connected external power source (e.g., portable power source). For example, when starting to use the power distribution device 100, the user inputs the maximum output power of the connected portable power source (e.g., “1000W” or “2000W”) via the touch panel TP. The controller 160 stores the input maximum output power in the storage unit 150 and determines that a power shortage state exists (in a supply shortage state) when the total power consumption of all load devices connected to the load connection portion 110 and the second load connection portion 170 exceeds a permissible value set based on this upper limit. This enables the power distribution device 100 to perform appropriate power management and load disconnection control (described later) according to its capacity, not only when connected to commercial power sources but also when connected to portable power sources and the like having limited capacity.(Second Modification Example)

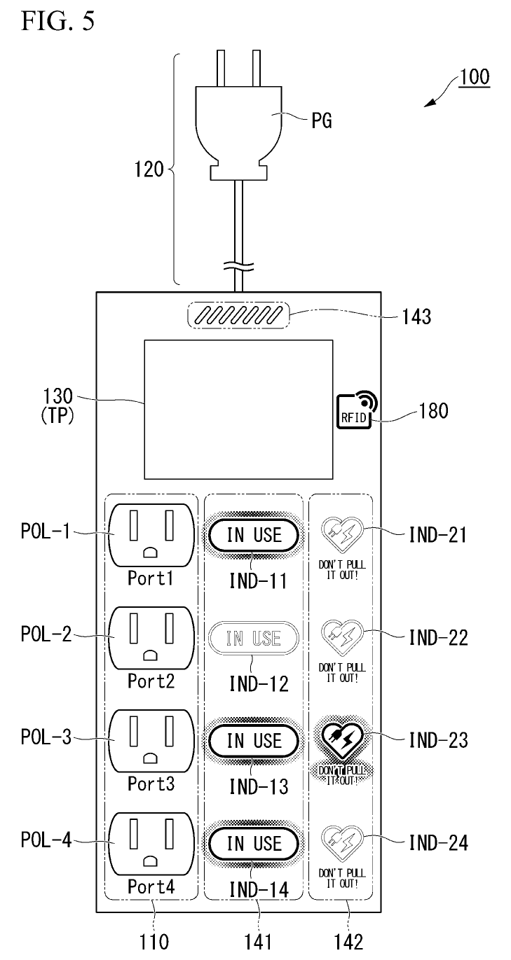

FIG. 5 is a diagram showing a second modification example of the power distribution device 100. The power distribution device 100 of the modification example further includes a radio frequency identification (RFID) reader 180 as an input means for information about the priority device setting. Thereby, the power distribution device 100 of the modification example can replace the user’s operation input with an RFID tag. For example, when setting information about the priority device setting is stored in the RFID tag, the priority device setting part 161 may be configured to read the setting information from the RFID tag via the RFID reader 180 and register the setting information in the setting information table T1. This is convenient because the user does not need to manually input information about the priority device setting. Moreover, for example, when credential information about a change in the priority device setting is stored in the RFID tag, the setting-change authentication part 163 may be configured to read the credential information from the RFID tag via the RFID reader 180. Thereby, it is possible to eliminate the user’s effort to input credential information while preventing unauthorized leakage of credential information by distributing RFID tags storing credential information to users who have been pre-authorized to change the settings. Thus, according to the second modification example, it is possible to improve both the convenience and operational security of the power distribution device 100.

In the example shown in FIG. 5, the specific control flow when reading information of the priority load (medical equipment, etc.) to be connected with RFID and the like is described. Since there is only one RFID reader 180 in this example, the controller 160 performs processing to associate the read device information with the target outlet for connection. Additionally, the controller 160 executes one of the following four control patterns (A) to (D) based on the power consumption (required power) of the read device, the current supply capacity, and the availability of free outlets (outlets to which no load devices are substantially connected).
(A) When sufficient power is available and there are free outlets: the controller 160 determines one recommended outlet (e.g., Port 1) from among the vacant outlets as the connection destination (connection-destination-connection-part). Then, the controller 160 notifies (guides) the user of the connection location, for example, by flashing the first indicator IND-11 or the second indicator IND-21 corresponding to that outlet. Alternatively, an outlet selection screen may be displayed on the touch panel TP, allowing the user to manually select the connection destination.
(B) When sufficient power is available but no outlets are free: the controller 160 selects an outlet to be a target for change from among outlets without being set to priority device setting (non-priority loads). Then instructs via the notification part, such as the touch panel TP, suggesting a physical connection change, e.g., “Please disconnect the device from Port 1 and connect the medical device”.
(C) When power is insufficient and there are free outlets: Since connecting the priority load to be connected would exceed the allowable power capacity, therefore, before the plug is connected, the controller 160 determines which outlet (an existing outlet not connected to a priority load) will be disconnected based on the disconnection criteria (such as order of smallest power consumption), as described later. Subsequently, for example, power supply to the target outlet is cut off to secure the necessary power. After that, the controller 160 guides the user to connect to an available outlet, similar to the above (A). This prevents system down caused by overload during connection. In other examples, the controller 160 may not immediately cut off power, and it may warn that power supply to the cutoff target outlet will be stopped using the third notification unit 143 (speaker) or the touch panel TP and may count down a predetermined grace period. In this case, after the grace period elapses, it cuts off the power supply to secure the necessary power. Furthermore, loads identified as important equipment such as medical devices via RFID may be designated as “prohibited from disconnection” or “final disconnection targets.” and this allows power supply to be maintained for them with priority over other general loads. Additionally, safety measures such as data preservation for the equipment subject to disconnection can be implemented.
(D) When power is insufficient, and no outlets are free: the controller 160 must secure both power and space. Therefore, the controller 160 cuts power to an existing outlet that is not a priority load (e.g., Port 1) using the same procedure as described in (C) to secure the necessary power and then notifies the user to unplug the plug connected to that outlet (Port 1) and connect the new priority load. Fourth power outlet (Port 4): 0 W

### Other Modification examples

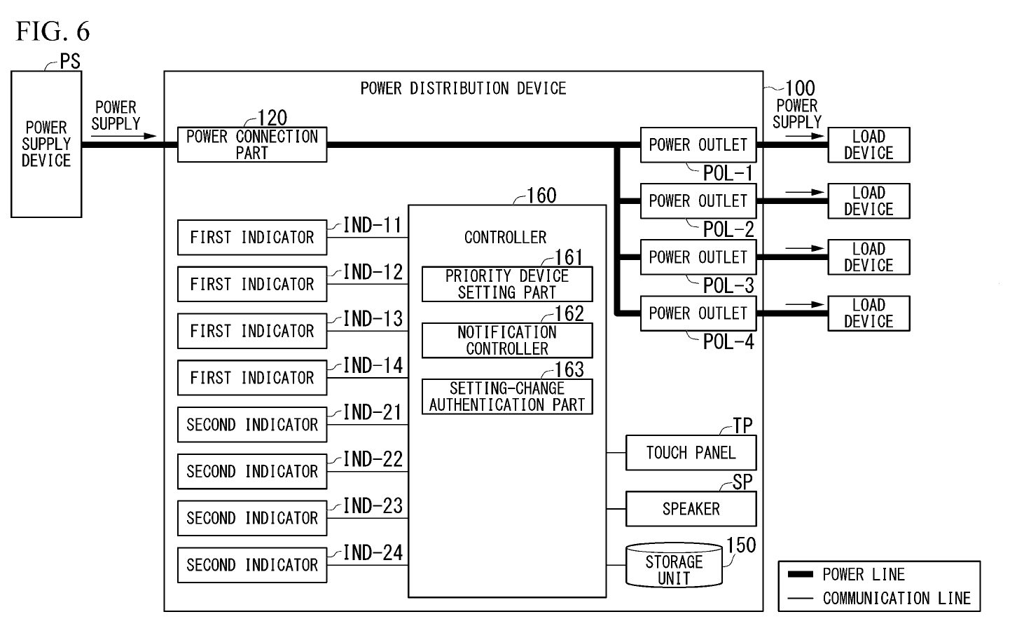

The power distribution device 100 may be configured without including a communication line connecting the controller 160 and each power outlet. That is, the controller 160 may be configured as a management part that manages notification operations, settings, and the like related to each power outlet, without performing direct control of each power outlet itself. In this case, the power distribution device 100 can function as a power branching device 100 shown in FIG. 6. FIG. 6 is a diagram showing an example of the power branching device 100 of a modification example.

### Second Embodiment

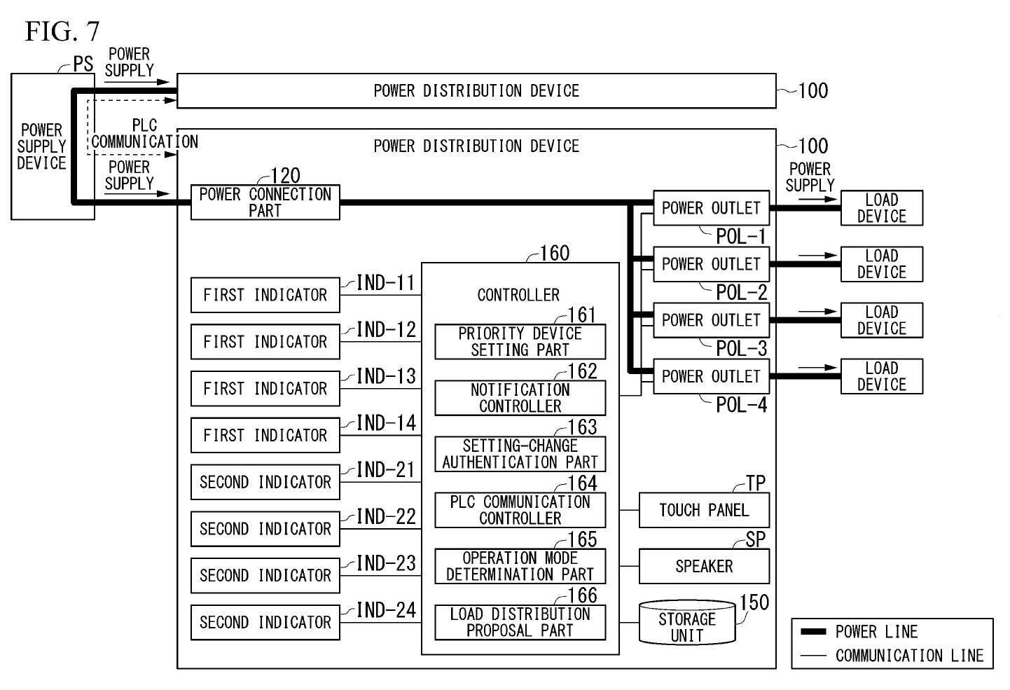

FIG. 7 is a diagram showing an example of a configuration of a power distribution device 100 according to a second embodiment. The power distribution device 100 of the second embodiment is different from the power distribution device 100 of the first embodiment in that a controller 160 further includes a PLC communication controller 164, an operation mode determination part 165, and a load distribution proposal part 166. The other configuration is similar to that of the first embodiment. Hereinafter, differences from those of the first embodiment will be mainly described and descriptions of similar functions will be omitted.

In this embodiment, “power supply device PS” refers to a power source that supplies power to the power distribution device 100, and refers to a device or facility that participates in forming an electrical circuit enabling PLC communication signals to be transmitted between the power distribution device 100 and power lines, as well as between multiple connected power distribution devices 100. The power supply device PS may be, for example, a portable power source (battery) or generator, or it may be a wall outlet or distribution panel for power installed in a building. The PLC communication controller 164 controls PLC (Power Line Communication) communication via this power supply device PS. For example, PLC communication is a communication technology that also uses power lines used for power supply as communication lines.

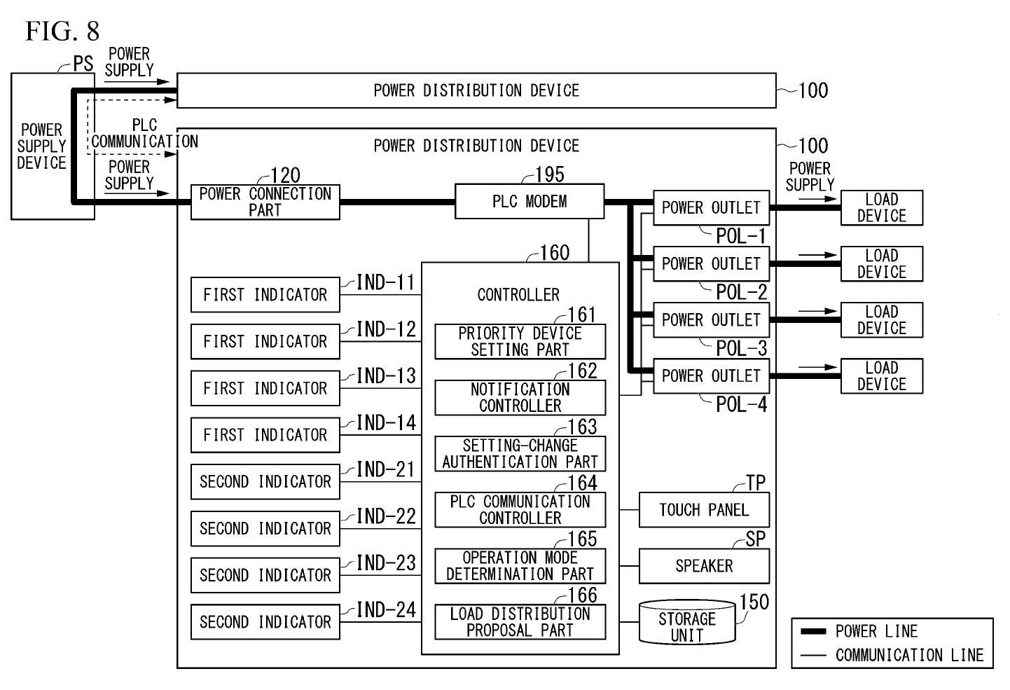

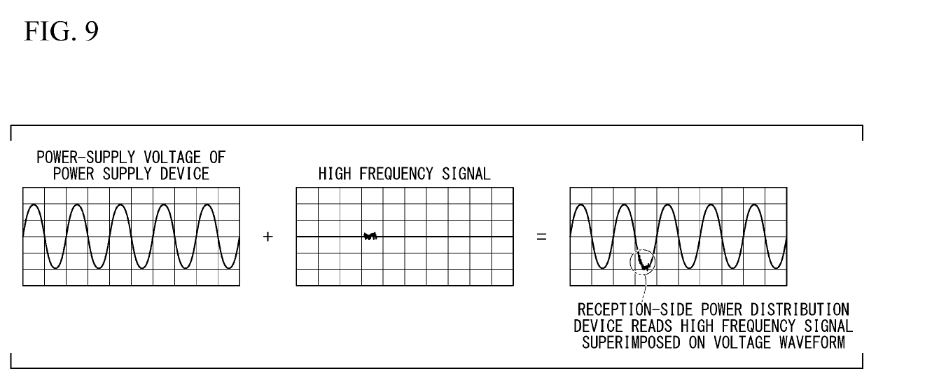

The PLC communication controller 164 controls power line communication (PLC) communication via a power supply device PS. The PLC communication is communication technology that also uses a power line, which is originally used for power supply, as a communication line. In the PLC communication, a high-frequency signal for communication is superimposed on a low-frequency signal for power supply and transmitted. For example, the power distribution device 100 may include a PLC (Power Line Communication) modem 195, as shown in FIG. 8, for superimposing high-frequency signals. FIG. 9 is an image diagram of the PLC communication. As shown in FIG. 9, the PLC communication controller 164 transmits information by superimposing a high-frequency signal for communication on a voltage waveform (low-frequency signal) of a power supply device PS, and receives information by separating the high-frequency signal superimposed on the voltage waveform. Additionally, encryption and authentication may be used during communication.

The operation mode determination part 165 periodically broadcasts identification information of its own device according to communication via the PLC communication controller 164, thereby transmitting the presence of its own device. Meanwhile, when the presence of another power distribution device 100 is recognized based on received identification information, the operation mode determination part 165 determines and sets an operation mode to be set for its own device. Operation modes include, for example, a first mode, a second mode, and a third mode. The first mode is a mode in which the device operates as one main device while there are other power distribution devices 100 connected to the same power supply device PS. The second mode is a mode in which the device operates as a sub-device other than the main device while there are other power distribution devices 100 connected to the same power supply device PS. The third mode is a mode in which its own device operates independently when the presence of another power distribution device 100 is not recognized. The “main device” may be defined as the device that possesses the authority to determine (or propose) matters such as the necessity of load balancing or the content of connection changes among multiple cooperating devices, or the device that issues commands. The “sub-device” may be defined as the device that provides information (such as load information) to the main device as a basis for its decisions, or the device that operates in response to commands (proposals) from the main device. Furthermore, for example, when multiple devices possess the function to determine control content, the device whose determination (command) takes precedence over the others can be designated as the “main device.” The power distribution device 100 in the third mode can function as the power distribution device 100 of the first embodiment.

The operation mode determination part 165 determines an operation mode of its own device based on identification information of its own device and the other power distribution devices 100. Here, the identification information of each power distribution device 100 is a unique number (individual identification number) of each power distribution device 100, which is stored in advance in the storage unit 150 of each device. For example, the identification information is unique to the power distribution unit 100 and is used as information representing the group of connection points (group of outlets) possessed by the power distribution device 100. The operation mode determination part 165 compares an individual identification number of its own device with those of the other power distribution devices 100 whose presence is recognized, recognizes that its own device is the main device when the individual identification number of its own device is the smallest, and decides the operation mode as the first mode. Moreover, when there is another device having a smaller individual identification number than its own device, the operation mode determination part 165 recognizes that its own device is a sub-device and decides the operation mode as the second mode. In addition, the method for deciding the operation mode may be any other method as long as it is a method by which one main device can be decided from the identification information according to a predetermined rule.

The load distribution proposal part 166 proposes a power load distribution among a plurality of power distribution devices 100 connected to the same power supply device PS to the user. More specifically, the load distribution proposal is implemented by a plurality of load distribution proposal parts 166 of the plurality of power distribution devices 100 executing the following processes according to their respective operation modes.

### Process in Second Mode

When the operation mode of its own device is the second mode (sub-device), the load distribution proposal part 166 periodically transmits load information about the load of its own device to the main device. The load information includes power outlet-specific power consumption of the load device.

### Process in First Mode

On the other hand, when the operation mode of its own device is the first mode (main device), the load distribution proposal part 166 recognizes the load statuses of the sub-devices based on the load information received from the sub-devices, and decides a load device (hereinafter referred to as a target device) for which a change of a connection destination (change of connection-destination-connection-part) to another power distribution device 100 is recommended and the power distribution device 100 serving as its changing destination by integrating the load status of the sub-device and the load status of its own device. The “change of the connection destination” may include both “moving”—unplugging the target device from its current outlet and reconnecting it to another available outlet—and “swapping (exchanging)”—physically exchanging the target device with another load device connected to that other outlet. The load distribution proposal part 166 notifies the user of proposal information about the target device and the power distribution device 100 serving as its changing destination. The load distribution proposal part 166 may provide a notification of the proposal information by displaying the notification on the touch panel TP or by outputting the notification as a sound from the speaker SP. Moreover, the load distribution proposal part 166 may be configured to provide the notification of the proposal information to the sub-devices by transmitting the proposal information to other power distribution devices 100 (i.e., the sub-devices).

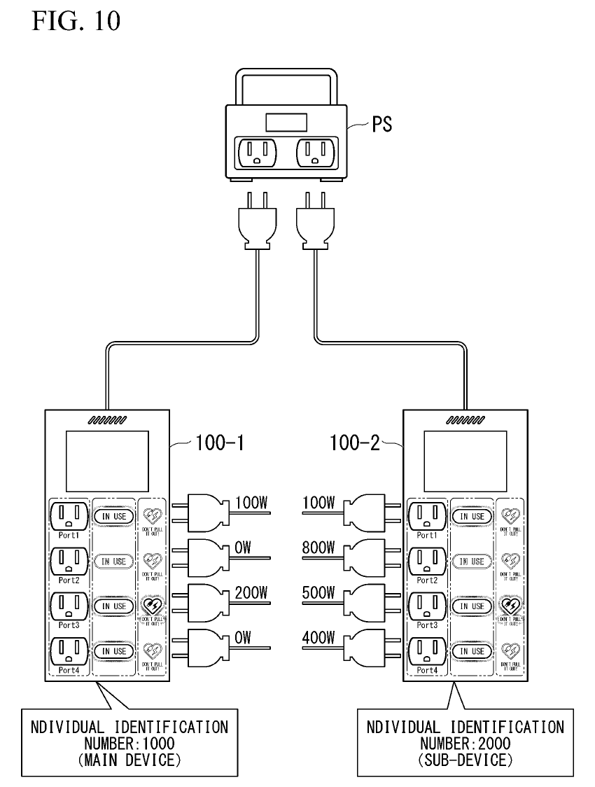

FIG. 10 is a diagram showing an example of a load distribution proposed by the load distribution proposal part 166 and/or a control when power is getting short. FIG. 10 shows an example in which two power distribution devices 100-1 and 100-2 are connected to the same power supply device PS. In this example, the power distribution device 100-1 having a relatively small individual identification number (1000 in FIG. 10) is the main device, and the power distribution device 100-2 having a relatively large individual identification number (2000 in FIG. 10) is the sub-device. In this example, the load statuses of the main device and the sub-device are as follows. In the following load statuses, “0 W” indicates a status in which there is no power consumption, which typically corresponds to either the case where no load device is connected or the case where a connected load device is in a power-off state.

### Load Status of Main Device

First power outlet (Port 1): 100 W

Second power outlet (Port 2): 0 W

Third power outlet (Port 3): 200 W

Total: 300 W

### Load Status of Sub-device

First power outlet (Port 1): 100 W

Second power outlet (Port 2): 800 W

Third power outlet (Port 3): 500 W

Fourth power outlet (Port 4): 400 W

Total: 1800 W

The load distribution proposal part 166 may decide the content of the proposed load distribution according to any criterion as long as the following conditions are satisfied.

(First Condition) A power outlet whose priority device setting is set to ON shall not be included as a connection change target (a moving source and a moving destination).

(Second Condition) A difference between maximum and minimum values of the total load becomes smaller after the load distribution.

Load balancing proposals shall be made within the permissible range based on the maximum output power of the power supply device PS. If the total power consumption is determined to exceed this permissible value, the power cutoff control described later may be executed with priority.

In the load statuses of the above-described example, the load distribution proposal part 166 of the main device, excluding those power outlets whose priority device settings are set to ON (the third power outlet of the main device and the third power outlet of the sub-device) from connection change targets, can propose, for example, a process for moving the load device of 800 W connected to the second power outlet of the sub-device to the second power outlet or the fourth power outlet of the main device. When this proposed load distribution is implemented, a total load of the main device becomes 1100 W, and a total load of the sub-device becomes 1000 W, thereby leveling the loads.

The aforementioned load balancing proposal assumes that the destination power distribution device 100 (such as the main unit) has available outlets (outlets to which no load equipment is effectively connected). However, when there are no available outlets at the destination, or during “power-constrained state” where moving does not resolve the power shortage, the controller 160 controls the relay circuit inside the outlet to perform control that cuts off power supply to some outlets. For example, power cutoff is executed when any one of the following conditions (1) to (3) is satisfied.
(1) When the total power consumption at a single power distribution device 100 exceeds the allowable value (e.g., 1500W), and there are no available outlets on other power distribution devices 100 connected to the same power supply device PS.
(2) When the total power consumption of all power distribution devices 100 connected to a power supply device PS exceeds the allowable value set based on the maximum output power (upper limit) of that power supply device PS, and there are no available outlets on any power distribution device 100 connected to a different power supply device PS ( This condition applies when multiple power supply devices PS exist within the system, as described in the third embodiment below).
(3) When the power consumption (or required power) of a load device to be connected is acquired via an RFID reader 180 and the like, it is determined that connecting that load device would result in a state matching either (1) or (2) above.

In one example, when performing the above power disconnection, the controller 160 excludes outlets (such as Port 3 in FIG. 10) where the priority device setting is ON from the disconnection targets, and then selects outlets to disconnect from among those without a priority device setting based on one of the following criteria. The first criterion is a method that disconnects outlets in order of smallest power consumption. Ports with higher power consumption may have multiple load devices connected via power strips, etc. and disconnecting these could cause a wider impact. Therefore, disconnecting ports in order from the lowest power consumption minimizes the impact. The second criterion is a method that disconnects in order of highest power consumption. Disconnecting one high-power load allows power supply to continue to more ports. The third criterion is a method that combines ports with power consumption equivalent to the power shortage and shuts them down. This allows the supply capacity of the power supply unit (PS) or similar device to be utilized to its maximum extent. The fourth criterion is a method that, in addition to the ON/OFF settings for priority devices, sets more detailed priority degrees for each outlet and shuts them down in order from the lowest priority based on those degrees.

For example, in the situation shown in FIG. 10, the total power consumption of the sub-device (100-2) is 1800W, exceeding the allowable value (1500W) (corresponding to the above condition (1)). Here, if all outlets of the main device (100-1) are in use and there is no available port, the controller 160 performs the disconnection control according to the above criteria. When adopting the first criterion (in order of smallest power consumption), disconnection occurs in the order of Port 1 (100W) and Port 4 (400W), excluding the priority device Port 3 (500W), until the total power consumption is 1500W or less. In this case, disconnecting Port 1 and Port 4 results in a total of 1300W, resolving the overload. On the other hand, when adopting the second criterion (in order of highest power consumption), the non-priority device with the highest power consumption, Port 2 (800W), is disconnected. This allows power supply to Port 1 and Port 4 to be maintained while resolving the overload at a total of 1000W.

Furthermore, the controller 160 flexibly changes the target for disconnection in response to changes in priority device settings. For example, consider a scenario where the same power usage conditions as in FIG. 10 exist (Port 1: 100W, Port 2: 800W, Port 3:500W, Port 4: 400W), but the user has changed only Port 2 (800W) to have its priority device setting turned ON. In this case, adopting the second criterion (in order of highest power consumption), the controller 160 excludes Port 2, which has the highest power consumption, from the disconnection targets as the priority device. As a result, Port 3 (500W), which has the next highest power consumption, is selected as the target for disconnection, and power supply to it is stopped. This allows the operation of the highest-power device with higher priority (Port 2) to be maintained while resolving the overload condition (exceeding 1500W).

According to the power distribution device 100 of the second embodiment described above, it is possible to provide an alert (load distribution proposal) to the user according to the usage status.

For example, in the second embodiment, a load distribution among a plurality of power distribution devices 100 capable of communication according to PLC communication can be proposed to the user. Thereby, the user can operate the load devices connected to the power distribution devices 100 in more appropriate states by performing a load distribution according to the proposal. Furthermore, in the load distribution of the second embodiment, power outlets whose priority device settings are set to ON are excluded from the load distribution targets. Thus, the power distribution device 100 of the second embodiment can perform the overall load distribution while ensuring the safety of priority devices, thereby enabling load devices to be operated in more appropriate load statuses.

### Third Embodiment

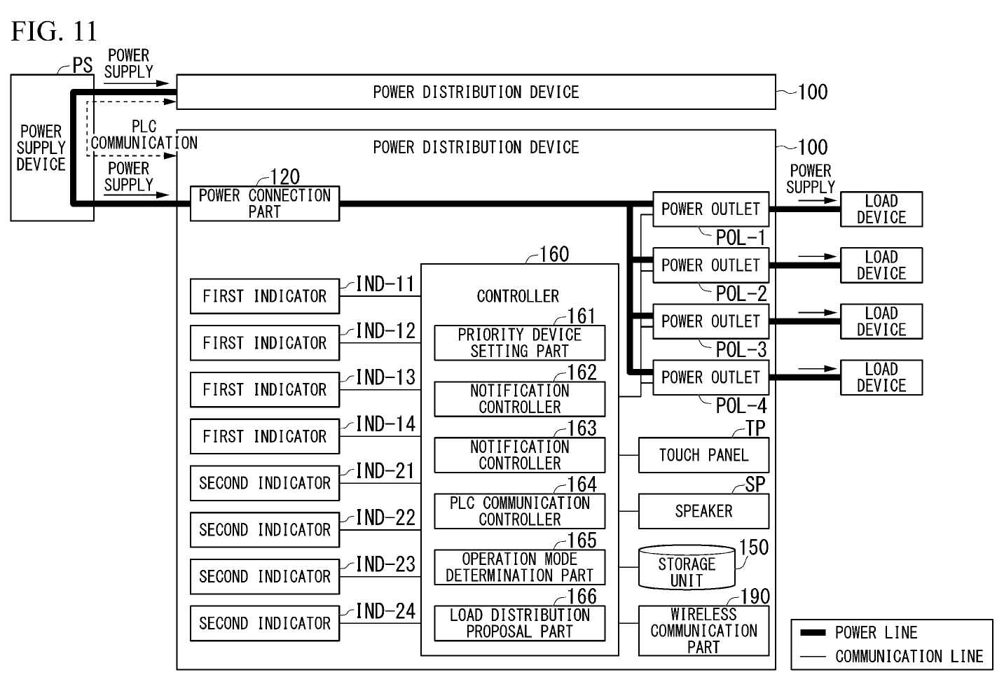

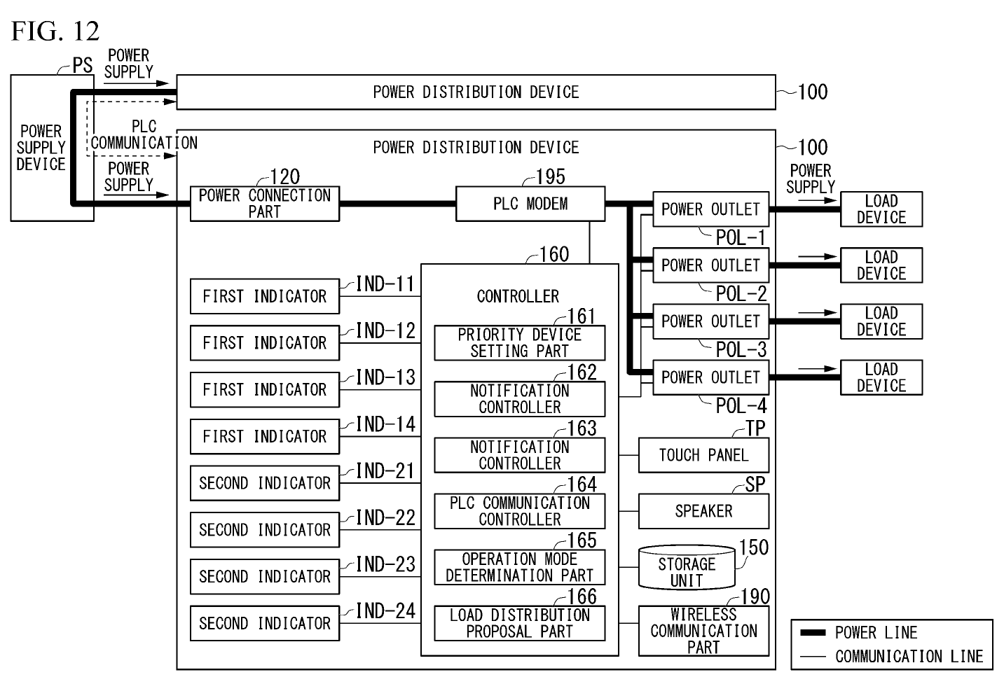

FIG. 11 is a diagram showing an example of a configuration of a power distribution device 100 according to a third embodiment. The power distribution device 100 of the third embodiment further includes a wireless communication part 190 and is different from the power distribution device 100 of the second embodiment in terms of some operations of the operation mode determination part 165 and the load distribution proposal part 166. The other configuration is similar to that of the second embodiment. For example, the power distribution device 100 may include a PLC (Power Line Communication) modem 195, as shown in FIG. 12, for superimposing high-frequency signals. Hereinafter, functions that differ from those of the second embodiment will be mainly described and descriptions of similar functions will be omitted.

The wireless communication part 190 is a communication interface for performing wireless communication with the wireless communication part 190 of another power distribution device 100. For example, the wireless communication part 190 may use a communication interface based on Bluetooth (registered trademark). Alternatively, the wireless communication part 190 may be a wireless local area network (LAN) interface, or a cellular communication interface corresponding to mobile communication standards such as third generation (3G) to fifth generation (5G). The wireless communication part 190 is activated when the operation mode of its own device is a first mode or a third mode to be described below and is used for wireless communication between the main devices. Additionally, encryption and authentication may be used during communication.

While the operation mode determination part 165 of the second embodiment determines the operation mode of its own device as any one of the first, second, and third modes, the operation mode determination part 165 of the third embodiment determines the operation mode of its own device as any one of the first, second, third, and fourth modes. The fourth mode is a mode in which, when the presence of a plurality of main devices including its own device is recognized according to communication via the wireless communication part 190, the device operates as a first main device representing the plurality of main devices. Hereinafter, main devices other than the first main device are referred to as second main devices. If three or more main devices exist within the wireless communication range, there is one first main device, but multiple second main devices may exist.

More specifically, the operation mode determination part 165 first performs PLC communication with the power distribution device 100 connected to the same power supply device as its own device, thereby determining the operation mode of its own device as any one of the first, second, and third modes. Here, when the operation mode is determined to be the first mode (i.e., when its own device is a main device), the operation mode determination part 165 activates the wireless communication part 190 to communicate with other main devices and determines whether or not its own device is the first main device. The operation mode determination part 165 changes the operation mode of its own device from the first mode to the fourth mode when its own device is the first main device and maintains the operation mode of its own device as the first mode when its own device is not the first main device. This determination is performed by comparing identification information, similar to the second embodiment. Specifically, the operation mode determination part 165 compares the identification information of the host device (first identification information) with the identification information of the other main device obtained via wireless communication (third identification information) and if the identification information of the own device is the smallest (or is prioritized according to a predetermined rule), it determines that the own device is the first main device (in this case, the own device is treated as the second main device).

While the load distribution proposal part 166 of the second embodiment proposes a load distribution within a range of the power distribution devices 100 connected to the same power supply device, the load distribution proposal part 166 of the third embodiment proposes a load distribution (hereinafter referred to as a global load distribution) within a range of power distribution devices 100 connected to a plurality of power supply devices. More specifically, the proposal of the global load distribution in the third embodiment is implemented when a plurality of load distribution proposal parts 166 of a plurality of power distribution devices 100 connected to a plurality of power supply devices execute the following process according to each operation mode. Because the process of the second mode is similar to that in the second embodiment, description thereof will be omitted.

### Process in First Mode

When the operation mode of its own device is the first mode (main device), the load distribution proposal part 166 recognizes the load statuses of the sub-devices based on the load information received from the sub-devices, and periodically transmits load information indicating the load statuses of its own device and the sub-devices to the first main device.

### Process in Fourth Mode

On the other hand, when the operation mode of its own device is the fourth mode (first main device), the load distribution proposal part 166 recognizes the load status of each of the second main device and the load status of the sub-devices connected to the same power supply device as each of the second main device (hereinafter referred to as second sub-devices) based on the load information received from one or more second main devices. The load distribution proposal part 166 comprehensively considers the load statuses of its own device (first main device), the sub-devices connected to the same power supply device as its own device (hereinafter referred to as first sub-devices), all of the second main device, and all of the second sub-devices, to decide a load device (hereinafter referred to as a target device) for which a connection change (movement) to another power distribution device 100 is to be recommended and the power distribution device 100 serving as its moving destination. The load distribution proposal part 166 notifies the user of proposal information about the target device and the power distribution device 100 serving as its moving destination.

The load distribution proposal part 166 may provide a notification of proposal information by displaying the notification on the touch panel TP or by outputting the notification as a sound from the speaker SP. Moreover, the load distribution proposal part 166 may be configured to transmit the proposal information to the second main device or the first sub-device, thereby allowing the second main device or the first sub-device to also provide the notification of the proposal information. Moreover, the load distribution proposal part 166 of the second main device may be configured to make the second sub-device to perform notification of the proposal information by transmitting the proposal information supplied from the first main device to the second sub-device.

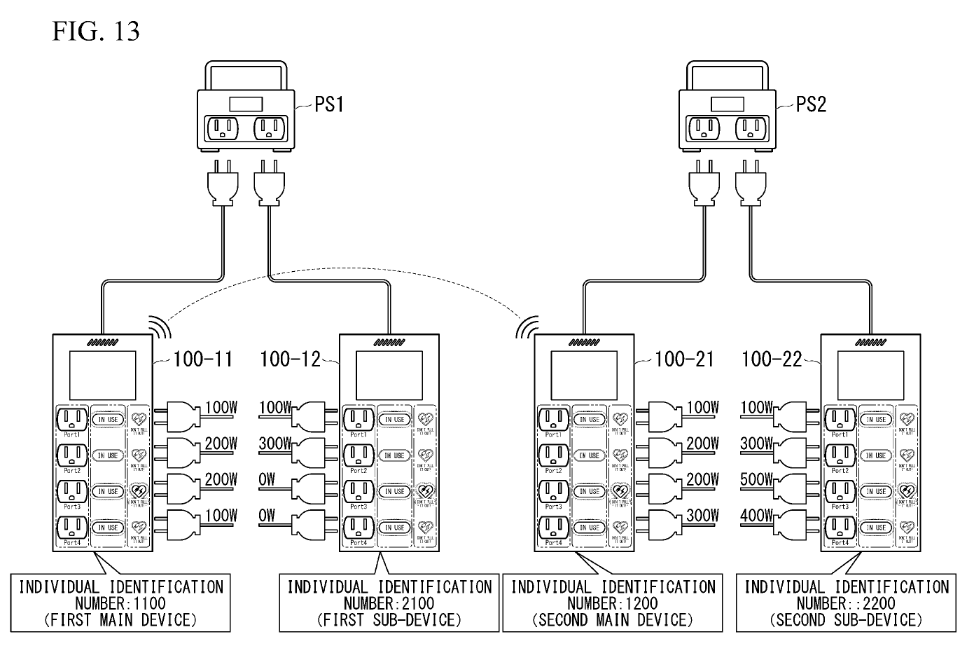

FIG. 13 is a diagram showing an example of a global load distribution proposed by the load distribution proposal part 166. FIG. 13 shows an example in which two power distribution devices 100 are connected to each power supply device PS-1 and PS-2. The power supply device PS-1 is connected to power distribution devices 100-11 and 100-12 and the power supply device PS-2 is connected to power distribution devices 100-21 and 100-22.

In this example, among the power distribution devices 100 connected to the power supply device PS-1, the power distribution device 100-11 having a relatively smaller individual identification number (1100 in FIG. 13) is the main device, and the power distribution device 100-12 having a relatively larger individual identification number (2100 in FIG. 13) is the sub-device.

Moreover, in this example, among the power distribution devices 100 connected to the power supply device PS-2, the power distribution device 100-21 having a relatively smaller individual identification number (1200 in FIG. 13) is the main device, and the power distribution device 100-22 having a relatively larger individual identification number (2200 in FIG. 13) is the sub-device.

Moreover, in this example, among the power distribution devices serving as main devices, i.e., the power distribution devices 100-11 and 100-21, the power distribution device 100-11 having a relatively smaller individual identification number (1100 in FIG. 13) is a first main device, and the power distribution device 100-21 having a relatively larger individual identification number (2200 in FIG. 13) is a second main device. As a result, the power distribution device 100-12 becomes a first sub-device, and the power distribution device 100-22 becomes a second sub-device. In this example, the load statuses of the first main device, the second main device, the first sub-device, and the second sub-device are as follows.

### Load Status of First Main Device

First power outlet (Port 1): 100 W

Second power outlet (Port 2): 200 W

Third power outlet (Port 3): 200 W

Fourth power outlet (Port 4): 100 W

Total: 600 W

### Load Status of First Sub-device

First power outlet (Port 1): 100 W

Second power outlet (Port 2): 300 W

Third power outlet (Port 3): 0 W

Fourth power outlet (Port 4): 0 W

Total: 400 W

### Load Status of Second Main Device

First power outlet (Port 1): 100 W

Second power outlet (Port 2): 200 W

Third power outlet (Port 3): 200 W

Fourth power outlet (Port 4): 300 W

Total: 800 W

### Load Status of Second Sub-device

First power outlet (Port 1): 100 W

Second power outlet (Port 2): 300 W

Third power outlet (Port 3): 500 W

Fourth power outlet (Port 4): 400 W

Total: 1300 W

The load distribution proposal part 166 may decide the content of a proposed load distribution according to arbitrary criterion as long as first and second conditions similar to those in the second embodiment are satisfied. In the example of the above-described load statuses, the load distribution proposal part 166 of the first main device, excluding the power outlets whose priority device settings are set to ON (the third power outlet of the first main device, the third power outlet of the first sub-device, the third power outlet of the second main device, and the third power outlet of the second sub-device) from the connection change targets, can propose, for example, a process for moving the load device of 400 W connected to the fourth power outlet of the second sub-device to the fourth power outlet of the first sub-device, and exchanging the load device of 200 W connected to the second power outlet of the first main device with the load device of 300 W connected to the fourth power outlet of the second main device. When this proposed load distribution is implemented, the total load of the first main device becomes 700 W, the total load of the first sub-device becomes 800W, the total load of the second main device becomes 700 W, and the total load of the second sub-device becomes 900 W, thereby leveling the loads.

According to the power distribution device 100 of the third embodiment described above, it is possible to provide an alert (a proposal for a global load distribution) to the user according to the usage status.

For example, in the third embodiment, the load distribution among a plurality of power distribution devices 100 capable of communication according to PLC communication can be proposed to the user. Thereby, the user can operate the load devices connected to the power distribution devices 100 in more appropriate states by implementing the load distribution according to the proposal.

Furthermore, in the third embodiment, the first main device can collect load information from the second main device according to wireless communication, such that a global load distribution can be proposed to the user. Thereby, the user can operate a larger number of load devices in more appropriate statuses using a plurality of power distribution devices 100 connected to a plurality of power supply devices by implementing the load distribution according to the proposal.

Furthermore, when a plurality of power supply devices are used as in the third embodiment, the power outlets whose priority device settings are set to ON are excluded from load distribution targets, as in the second embodiment. Thus, according to the power distribution device 100 of the third embodiment, as in the second embodiment, it is possible to perform the overall load distribution and operate a large number of load devices in more appropriate load statuses while taking into consideration the safety of priority devices.

Although the operation mode when the first power distribution device 100 operates independently is defined as the third mode in the second embodiment, it may be defined as the first mode in the third embodiment. Thereby, even if there is a power supply device to which only one power distribution device 100 is connected, this power distribution device 100 can be included in a global load distribution range.

### Example of Housing Shape Variation

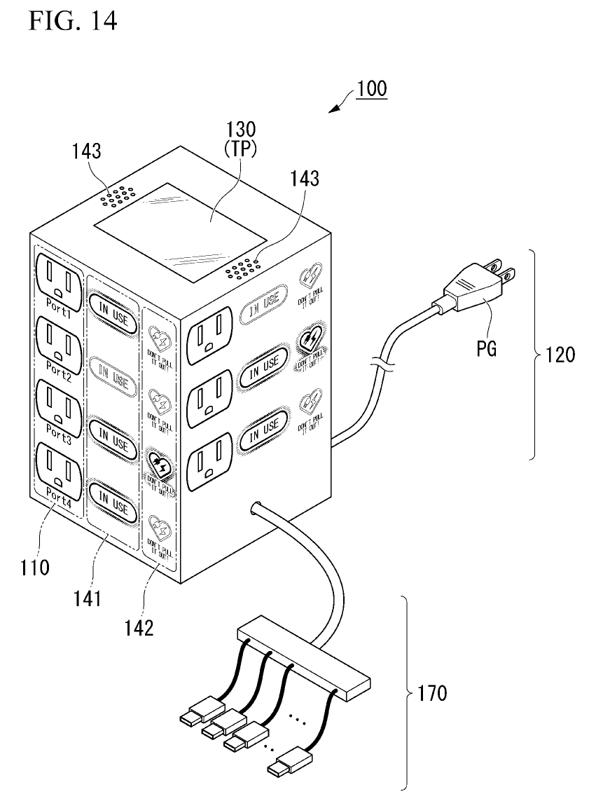

FIG. 14 is an illustration showing another variation example of the power distribution device 100. As shown in FIG. 14, the power distribution device 100 may have a three-dimensional tower-shaped (columnar) housing. In this example, the top surface of the housing accommodates a touch panel serving as an operation part 130 and a speaker serving as a third notification part 143. This configuration offers the advantage that even when the power distribution device 100 is installed on a floor surface or at a low position, users can easily view the screen from above and clearly hear notification sounds. Multiple outlets serving as load connection portions 110 are arranged on the side surfaces of the housing. Near each outlet, a first indicator 141 (available outlet display) using LED illumination, etc., shows the outlet's status (available/in use), and a second indicator 142 (life-support port display) shows that the outlet is designated for priority equipment (e.g., life-support equipment as illustrated). For example, the second indicator 142 can be configured to visually emphasize importance, such as by illuminating a heart-shaped icon in red. Furthermore, in FIG. 14, the power distribution device 100 may also include a smartphone charging station. This charging station corresponds to the second load connection section 170 (DC power supply section) described in FIG. 4 and functions as a hub capable of simultaneously charging multiple mobile devices. Thus, by forming the housing in a tower shape, it becomes possible to reduce the installation area (footprint) while facilitating plug connections from multiple directions and providing a highly visible interface. A housing as shown in FIG. 14 can be applied to the power distribution device 100 of any of the first to third embodiments.

### Modification Examples Common to Embodiments

Although examples of an indicator or touch panel for a visual notification and a speaker for an auditory notification have been described as a means for notifying the user of the power distribution device 100 in the embodiments, the means for providing a notification to the user is not limited thereto and may be a device that provides a notification related to another sense. For example, the notification means may provide a notification related to the user’s tactile sense. As a notification means for providing the notification related to the user’s tactile sense, for example, a device capable of dynamically changing Braille patterns and the like may be considered.

Although a case where the controller 160 of the power distribution device 100 includes the priority device setting part 161, the notification controller 162, the setting-change authentication part 163, the PLC communication controller 164, the operation mode determination part 165, and the load distribution proposal part 166 has been described in the embodiment, when the power distribution device 100 is capable of communicating with another control device, some or all of these functional units may be provided in the other control device. In other words, the processor configured to execute a process for controlling the priority device setting part 161, the notification controller 162, the setting-change authentication part 163, the PLC communication controller 164, the operation mode determination part 165, the load distribution proposal part 166, and the like does not necessarily need to be located inside the power distribution device 100, and may be located in arbitrary device capable of communicating with the power distribution device 100. For example, the control function of the power distribution device 100 may be provided on the power supply device side.

Although the case in which the controller 160 determines the operation mode and executes a process according to the operation mode has been described in the embodiment, an operation mode determination part and a dedicated controller for each operation mode may be provided in the power distribution device 100.

Although a case where the controller 160 determines the operation mode and executes a process corresponding to the operation mode has been described in the embodiment, the power distribution device 100 may be configured as a different device dedicated to each operation mode.

In the embodiments, the case where a “priority device setting” is set for a power outlet to which a load device (priority device) to be prioritized is connected has been described. In contrast, instead of the priority device setting, a “subordination device setting” may be set for a power outlet to which a load device (subordination device) with a lower priority degree is connected. In this case, the controller 160 may be configured to perform a control process by replacing the power outlet having the priority device setting with a power outlet that does not have the subordination device setting in the embodiment.

Although two values of a binary setting of ON (a priority device is connected) and OFF (a load device that is not the priority device is connected) are exemplified in the embodiment, the priority device setting (or the above-described subordination device setting) may be set as a priority degree of two or more values. Moreover, in this case, the controller 160 may operate functional units for various types of notifications in an aspect according to each priority degree. For example, the controller 160 may change the display color of the indicator, the display content on the touch panel, or the content of the audio output in accordance with the priority degree or may cause the indicator to flash in a pattern according to the priority degree.

The priority/subordination degree may be set to three or more degrees (multiple values), not limited to two values. In this case, the controller 160 determines the disconnection sequence during power shortages based on that degree (rank). For example, the priority/subordination degrees can be set as: “High (life-saving medical equipment, etc.)”, “Medium (communication equipment, PCs, and other devices requiring data preservation)”, and “Low (home appliances that can be temporarily stopped, etc.)”. In this case, during power shortages, the controller 160 first cuts power to the “Low” outlets, which have the lowest priority (i.e., the highest subordination degree). If the shortage persists, it will then cut off power to “Medium” outlets, maintaining power to “High” outlets until the very last moment. Furthermore, this rank information may be written to the aforementioned RFID tags. By having the RFID reader 180 read the “rank information” from the tags, multi-degree prioritization and the resulting precise power management become possible automatically upon connection, without requiring user setting operation.

In one embodiment, the controller 160 (load balancing proposal part 166) is illustrated as “proposing” load balancing or connection changes to the user. However, the controller 160 may omit the proposal process and “automatically execute” power supply interruption or resumption based on the determined content. In one example, the power distribution device 100 includes “proposal mode (manual mode)” and “automatic control mode” as operational settings. When “Automatic Control Mode” is selected, upon detecting power shortage or the existence of a more efficient connection pattern, the controller 160 immediately controls the relay circuit of the target outlet based on the aforementioned cutoff criteria and priority settings, cutting off power supply (automatic power cutoff). Alternatively, it coordinates with other power distribution devices 100 via PLC communication or wireless communication, enabling each device to autonomously switch power supply on/off to balance overall system power consumption. This allows the system to automatically maintain power supply-demand balance and avoid blackouts (total power outages) even in unattended environments or during emergencies requiring immediate response. Furthermore, after power supply is cut off in automatic control mode (after automatic disconnection), the controller 160 resumes power supply when predetermined restoration conditions are met. The restoration conditions include, for example, any one or a combination of the following conditions can be adopted: (1) After a shutdown occurred because the total power consumption exceeded a permissible value set based on the maximum output power (upper limit) of the power supply device PS, the total power consumption subsequently fell below a sufficiently low restoration threshold (e.g., 1200W) relative to the permissible value, such as a shutdown threshold (e.g., 1500W); (2) A specified time period (e.g., 5 minutes) has elapsed, or (3) The user has performed a release operation (inputting a safety confirmation) via the operation panel 130 or the RFID reader 180. This prevents the phenomenon of repeated power supply interruptions and restarts within a short period, thereby preventing failure of the connected load equipment.

The power distribution device 100 of the embodiment and its modification examples are examples of a power branching device. Moreover, the load device is an example of a power-consuming device. Moreover, the priority device setting is an example of a priority/subordination degree.

The “indicating a relatively high priority in the priority-subordination degree” means that when ‘priority’ is used as the measure of priority-subordination, the value is large (high), and when “subordination” (e.g., the order or rank for power supply disconnection) is used, the value is small (low). In other words, regardless of the definition of the metric used, the controller 160 controls to exclude load equipment with a higher priority degree (priority rank) for maintaining power supply from being subject to disconnection or modification.

Furthermore, the term “power branching device” in this specification and the claims is not limited to a device having all components within a single housing. For example, as in the second and third embodiments (FIG. 10 and FIG. 12), when multiple power distribution devices (a main device and a sub-device, or multiple main devices) that are physically separated operate in coordination with each other via power lines or wireless communication, the entire system may be referred to as a “power branching device.” That is, a “power branching device” may be configured to include multiple power distribution devices. In such a case, the control unit of the first power distribution device (e.g., the main device) constituting the system functions as the “first controller,” and the control unit of the second power distribution device (e.g., the sub-device), which is separate from the first power distribution device, functions as the “second controller.”

In the second embodiment, the power outlet group of the main device is an example of a first connection portion group and the controller of the main device is an example of a first controller. Moreover, the power outlet group of the sub-device is an example of a second connection portion group, and the controller of the sub-device is an example of a second controller.

In the third embodiment, the power outlet group of the first main device is an example of a first connection portion group, and the controller of the first main device is an example of a first controller. Moreover, the power outlet group of the first sub-device is an example of a second connection portion group, and the controller of the first sub-device is an example of a second controller. Moreover, the power outlet group of the second main device is an example of a third connection portion group, and the controller of the second main device is an example of a third controller. Moreover, the power outlet group of the second sub-device is an example of a fourth connection portion group, and the controller of the second sub-device is an example of a fourth controller. Furthermore, the transmission and reception functions possessed by the PLC communication control unit and the wireless communication unit are examples of transmission and reception parts, respectively. Specifically, when a control unit (such as a main controller or sub-controller) outputs a signal using the PLC communication control unit, the PLC communication control unit functions as a transmission part. When it inputs a signal, the PLC communication control unit functions as a reception part.

Although modes for carrying out the present invention have been described using embodiments, the present invention is not limited to the embodiments and various modifications and substitutions can also be made without departing from the scope of the present invention.

What is claimed is:

1. A power branching device comprising:
a plurality of connection portions to which a plurality of power-consuming devices are detachably connected, respectively;
an acquisition unit configured to acquire priority/subordination degrees that are priority degrees or subordination degrees of the plurality of power-consuming devices connected to the plurality of connection portions, respectively; and
a notification unit configured to notify a user of one priority/subordination degree, which is the priority/subordination degree of one power-consuming device acquired by the acquisition unit among the plurality of power-consuming devices, in association with one connection portion which is the connection portion to which the one power-consuming device is connected.

2. The power branching device according to claim 1, further comprising:
a first control unit configured to control a first connection portion group among the plurality of connection portions; and
a second control unit configured to control a second connection portion group different from the first connection portion group.

3. The power branching device according to claim 2,
wherein the first control unit includes a first transmission unit configured to transmit first identification information indicating the first connection portion group, and
wherein the second control unit includes a second transmission unit configured to transmit second identification information indicating the second connection portion group.

4. The power branching device according to claim 3,
wherein the first connection portion group and the second connection portion group are electrically connectable via a power line, and
wherein the first transmission unit transmits the first identification information to the second control unit via the power line.

5. The power branching device according to claim 3,
wherein the first connection portion group and the second connection portion group are electrically connectable via a power line, and
wherein the second control unit includes a reception unit configured to receive the first identification information via the power line.

6. The power branching device according to claim 3, wherein the first control unit and the second control unit identify whether the first control unit or the second control unit is a main control unit or a sub-control unit based on the first identification information and the second identification information.

7. The power branching device according to claim 6, wherein, when the first control unit is the main control unit and the second control unit is the sub-control unit,
the second transmission unit measures power consumption of the connected power-consuming device for each connection portion included in the second connection portion group and transmits to the first control unit, and
the first control unit outputs proposal information for proposing a change of connection-destination-connection-unit of the power-consuming devices so that total power consumption between the first connection portion group and the second connection portion group is leveled.

8. The power branching device according to claim 7, wherein, while excluding the connection portion connected with the power-consuming device having a high priority/subordination degree among the first connection portion group and the second connection portion group from an object of the change, the first control unit decides the connection portion which is the object of the change so that the total power consumption is leveled.

9. The power branching device according to claim 3, further comprising a wireless communication unit configured to perform wireless communication with an other power branching device different from the power branching device,
wherein the first transmission unit transmits the first identification information to a third control unit that is the first control unit of the other power branching device, via the wireless communication unit, and receives third identification information indicating a third connection portion group that is the first connection portion group of the other power branching device from the third control unit.

10. The power branching device according to claim 9, wherein the first control unit identifies, based on the first identification information and the third identification information, whether the first control unit itself is a first main control unit representing main control units or a second main control unit that is a main control unit other than the first main control unit.

11. The power branching device according to claim 10, wherein, when the first control unit is the first main control unit and the third control unit is the second main control unit,
the first main control unit acquires information indicating power consumption of the power-consuming devices connected to the third connection portion group and indicating the power consumption for each connection portion included in the third connection portion group from the third control unit, and
the first main control unit outputs proposal information for proposing a change of connection-destination-connection-unit of the power-consuming devices so that total power consumption among the first connection portion group, the second connection portion group, the third connection portion group, and a fourth connection portion group that is the second connection portion group of the other power branching device is leveled.

12. The power branching device according to claim 11, wherein, while excluding the connection portion connected with the power-consuming device having a high priority/subordination degree among the first connection portion group, the second connection portion group, the third connection portion group, and the fourth connection portion group from an object of the change, the first control unit decides the connection portion which is the object of the change so that the total power consumption is leveled.

13. The power branching device according to claim 2, further comprising an operation unit configured to receive an operation of the user,
wherein, when an operation for changing a priority/subordination degree setting is input, the first control unit and the second control unit request the user to input credential information and permit the change in the setting only when the input information matches credential information registered in advance.

14. A power branching method for a power branching device comprising:
a plurality of connection portions to which a plurality of power-consuming devices are detachably connected, respectively, and a plurality of notification units corresponding to the plurality of connection portions, respectively, the method comprising:
acquiring priority/subordination degrees that are priority degrees or subordination degrees of the plurality of power-consuming devices connected to each of the plurality of connection portions; and
notifying a user of one priority/subordination degree, which is the acquired priority/subordination degree of one power-consuming device among the plurality of power-consuming devices, by using the notification unit which is among the plurality of notification units and which is corresponding to one connection portion that is the connection portion to which the one power-consuming device is connected.

15. A non-transitory computer-readable storage medium storing a computer program for causing a computer of a power branching device including a plurality of connection portions to which a plurality of power-consuming devices are detachably connected, respectively, and a plurality of notification units corresponding to the plurality of connection portions, respectively, to execute:
a process for acquiring priority/subordination degrees that are priority degrees or subordination degrees of the plurality of power-consuming devices connected to each of the plurality of connection portions; and
a process for notifying a user of one priority/subordination degree, which is the acquired priority/subordination degree of one power-consuming device among the plurality of power-consuming devices, by using the notification unit which is among the plurality of notification units and which is corresponding to one connection portion that is the connection portion to which the one power-consuming device is connected.
